(19) United States
(12) Patent Application Publication
(10) Pub. No.: US 2010/0117033 A1
(43) Pub. Date: May 13, 2010

(54) Material, In Particular For Use In Electrochemical Cells Or Supercapacitors And A Method Of Making Such A Material

(76) Inventors: Yu-Guo Guo, Beijing (CN); Yong-Sheng Hu, Beijing (CN); Joachim Maier, Wiemsheim (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/529,535

(22) PCT Filed: Mar. 5, 2007
(86) PCT No.: PCT/EP07/01866

§ 371 Date: Jan. 14, 2010

(51) Int. Cl. H01B 1/24; H01B 1/08

(52) U.S. Cl. 252/507; 252/500; 252/520.2; 252/521.2; 252/518.1; 252/506

(57) ABSTRACT

A material in particular for use in electrochemical cells or supercapacitors comprises a poorly conducting active material of relatively low conductivity having regular or irregular passages having average cross-sectional dimensions generally in the size range from 5 μm to 200 nm and interconnected mesopores having average cross-sectional dimensions in the size range from 2 to 50 nm. The active material is covered with a network of an electronically conductive metal oxide of relatively high conductivity extending into said mesopores. Also claimed is a method of manufacturing such a material.

The present invention relates to a material, in particular for use in electrochemical cells or supercapacitors and to a method of making such a material.

One of the greatest challenges for our society is providing powerful electrochemical energy conversion and storage devices with high energy/power densities and high safety as well as low cost. Such devices could be potentially used in an electric vehicle (EV) or hybrid electric vehicle (HEV) and in other applications. Among all these devices, lithium-based batteries are the most promising candidate in terms of energy density, whilst the achievement of high power density is hindered by kinetic problems of the electrode materials. In the above connection, reference can be made to the papers by J. M. Tarascon and M. Armand in Nature 2001, 414, 359;

A. S. Arico, P. G. Bruce, B. Scrosati, J. -M. Tarascon, W. Van Schalkwijk, in Nature Mater. 2005, 4, 366,

However, the achievement of high power density, which requires relatively large amounts of electrode material, is hindered by kinetic problems of the electrode materials. For example, in order to achieve a high rate capability of lithium batteries, rapid ionic and electronic diffusion is necessary. Such materials often involve relatively poorly conducting compounds which are mixed with conductive materials such as carbon black to improve conductivity. The combination of relatively poorly conducting materials and relatively good conductors is often referred to as mixed conduction. Extensive research work focuses on enhancing mixed conduction by doping the electrode materials with foreign atoms. Examples of this can be found in the papers named above and in the papers by S. B. Schougaard, J. Breger, M. Jiang, C. P. Grey, J. B. Goodenough, in Adv. Mater. 2006, 18, 905, D. Y. Wang, H. Li, S. Q. Shi, X. J. Huang, L. Q. Chen, in Electrochim. Acta 2005, 50, 2955 and J. Hu, H. Li, X. J. Huang, L. Q. Chen, in Solid State Ionics 2006, 177, 2791.

Mixed conduction can also be achieved by admixing electronically conductive phases (electronic wiring through carbon, Ag, conducting polymers, etc.). Examples of this can be found in some of the papers named above and in the papers by M. Nishizawa, K. Mukai, S. Kuwabata, C. R. Martin, H. Yoneyama, in J. Electrochem. Soc. 1997, 144, 1923; F. Zhang, S. Passerini, B. B. Owens, W. H. Smyrl, in Electrochem. Solid State Lett. 2001, 4, A221; N. Ravet, Y. Chouinard, J. F. Magnan, S. Besner, M. Gauthier, M. Armand, in J. Power Sources 2001, 97-8, 503; H. Huang, S. C. Yin, L. F. Nazar, in Electrochem. Solid State Lett. 2001, 4, A170; F. Croce, A. D. Epifanio, J. Hassoun, A. Deptula, T. Olczac, B. Scrosati, in Electrochem. Solid State Lett. 2002, 5, A47; R. Dominko, M. Bele, M. Gaberscek, M. Remskar, D. Hanzel, J. M. Goupil, S. Pejovnik, J. Jamnik, in J. Power Sources 2006, 153, 274

The wiring technique is widely applied to microsized or submicrosized particles (typically >50 nm) and was most systemically studied by Jamnik et al. as can be seen from the above referenced paper. A successful example of this is the well-known carbon coating technique used in the synthesis of LiFePO₄ electrode material. However, the rate performance enhancement of such electrode materials is still limited, as availability or percolation of the electronically conducting phase and/or the electrolyte become insufficient at very high rates. One of the reasons for this is that the carbon coating has been found to be non-continuous so that continuous conductive patterns are missing. The above referenced papers by Taberna et al and by Reiman et al refer to optimization procedures intended for high rate performance. P. L. Taberna, S. Mitra, P. Poizot, P. Simon, J. -M. Tarascon, in Nature Mater. 2006, 5, 567 and K. H. Reiman, K. M. Brace, T. J. Gordon-Smith, I. Nandhakumar, G. S. Attard, J. R. Owen, in Electrochem. Commun. 2006, 8, 517. One is the use of nano-architectured electrodes consisting of the electrochemical plating of Fe₃O₄ onto Cu nanorods acting as a current collector. The other is the use of porous TiO₂ thin films. Both designs lead to enhanced power performance but are naturally not meant for or suitable for achieving high energy demands because the thin films required make it impossible to achieve sufficient electrode material in a confined space for high energy applications.

The object of the present invention is to provide a material, in particular for use in electrochemical cells or supercapacitors and a method of manufacturing such a material which provide an optimized nanostructure design of materials for both high power and high energy use, in particular in lithium batteries, but also in a variety of other electrochemical devices and applications.

In order to satisfy this object there is provided, in accordance with the present invention, a material in particular for use in electrochemical cells or supercapacitors comprising a poorly conducting active material of relatively low conductivity having regular or irregular passages having average cross-sectional dimensions generally in the size range from 5 μm to 200 nm and interconnected mesopores having average cross-sectional dimensions in the size range from 2 to 50 nm and the active material being covered with a network of an electronically conductive metal oxide of relatively high conductivity extending into said mesopores.

Further there is provided a method of manufacturing such a material comprising the steps of making a material in particular for use in electrochemical cells or supercapacitors comprising the steps of preparing a poorly conducting active material of relatively low conductivity having regular or irregular passages having average cross-sectional dimensions generally in the size range from 5 μm to 200 nm and interconnected mesopores having average cross-sectional dimensions in the size range from 2 to 50 nm and the active material being covered with a network of an electronically conductive metal oxide of relatively high conductivity extending into said mesopores.

The material of the invention permits highly Li-permeable materials to be obtained by providing the material with a hierarchical, “self-similar” mixed conducting three-dimensional (3D) networks. The nanoscopic network structure is composed of a dense net of “metalized” mesopores that allow both Li⁺ and e⁻ to migrate. The term “metalized” is used here because the metal oxides used to form the “metalized mesopores” have electronic conductivity, i.e. a conductivity approaching that of metals. E.g. for RuO₂ the conductivity is 5*10⁴ S/cm For alternatives such as IrO₂, VO₂, MoO₂, WO₂, Co₃O₄ and Fe₃O₄ it is 2*10⁴ S/cm, 2*10³ S/cm, 5*10³ S/cm, 3*10² S/cm, ˜10² S/cm and 2.5*10² S/cm respectively. This network with a mesh size of about 10 nm is superimposed on a similar net on the micro-scale formed by the composite of the mesoporous particles and the conductive admixture. The power of this concept can be demonstrated by reference to Example 1 given below relating to the synthesis of a mesoporous TiO₂:RuO₂ nanocomposite which shows superior high rate capability when used as anode materials for lithium batteries as will be explained further below.

Preferred embodiments of the invention are set forth in the appended subordinate claims and incorporated into the description by reference.

The present invention will be explained in the following the more detail by way of example only and with reference to the accompanying drawings which show:

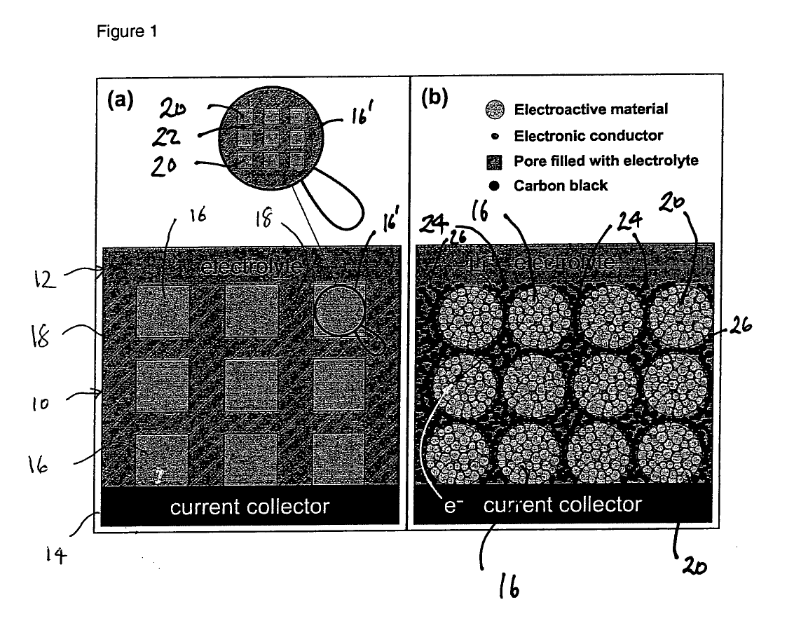

FIG. 1 (a) a conceptual representation of the desired inventive design comprising a “self-similar” structure concerning the transportation of ions from microscale to nanoscale, with shaded areas representing the efficient mixed conducting parts; (b) a sketch of a realistic composite meeting this concept,

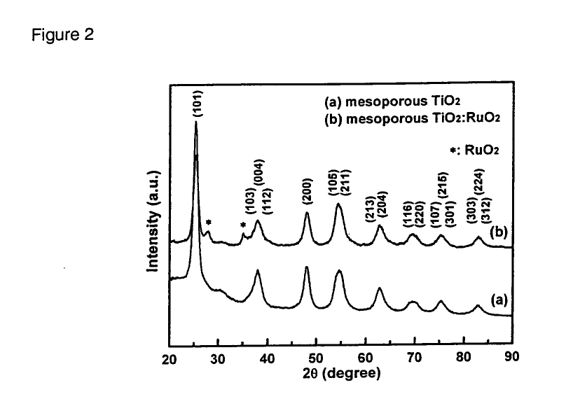

FIG. 2 X-ray diffraction patterns of (a) as-prepared mesoporous TiO₂ spheres and (b) a mesoporous TiO₂:RuO₂ nanocomposite,

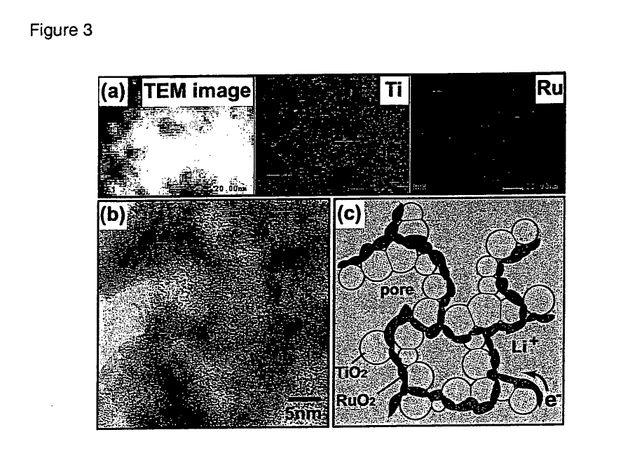

FIG. 3 Elemental mapping of a mesoporous TiO₂:RuO₂ nanocomposite in which (a) shows an annular dark-field TEM image of the mesoporous TiO₂:RuO₂ nanocomposite and corresponding Ti and Ru EDX maps; (b) shows a HRTEM image taken from the outer edges of a TiO₂:RuO₂ sphere and (c) shows a corresponding schematic illustration of the self-wired path of deposited RuO₂ nanoparticles,

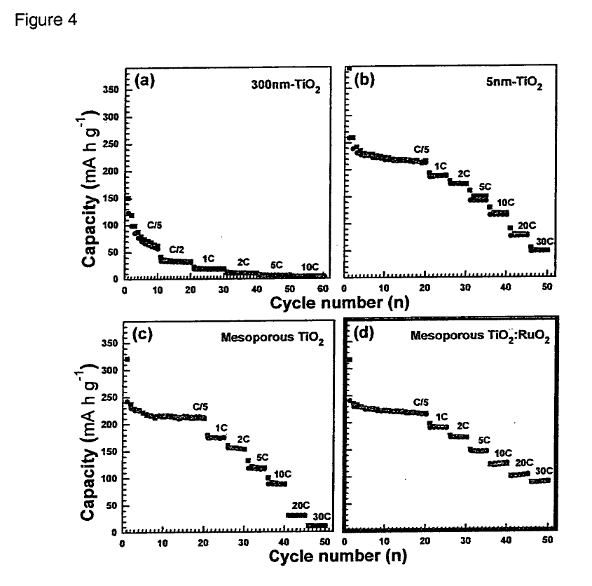

FIG. 4 Rate performance diagrams showing the variation of discharge (square)/charge (round) capacities versus cycle number for different anatase electrodes cycled at different rates between voltage limits of 1 and 3 V, more specifically for (a) 300 nm-TiO₂; (b) 5 nm-TiO₂; (c) mesoporous TiO₂; and (d) a mesoporous TiO₂:RuO₂ nanocomposite in accordance with the present invention,

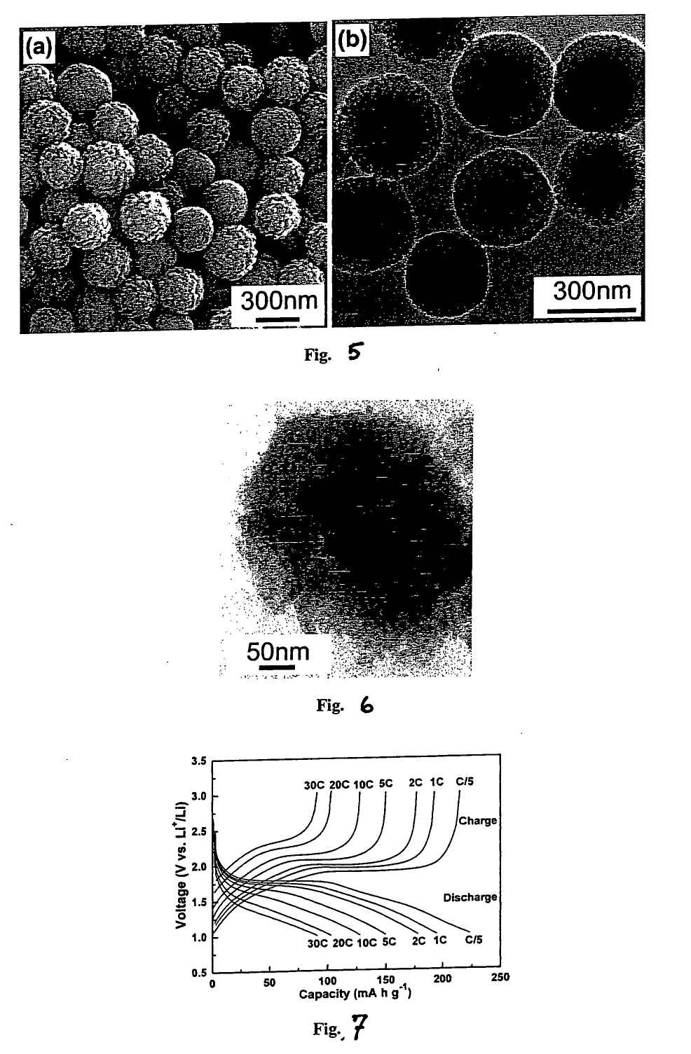

FIG. 5 Typical SEM (a) and TEM (b) images of mesoporous TiO₂ spheres,

FIG. 6 A typical TEM image of mesoporous TiO₂:RuO₂ spheres,

FIG. 7 Galvanostatic discharge/charge curves of mesoporous TiO₂:RuO₂ composite electrode cycled at different rates from C/5 to 30 C between voltage limits of 1 and 3 V,

FIG. 8 A typical TEM image of a mesoporous LiFePO₄ grain,

FIGS. 9 (a) and (b) typical HRTEM images to different scales of carbon coated LiFePO₄ after coating with RuO₂ and (c) a schematic drawing illustrating the effect of the RuO₂,

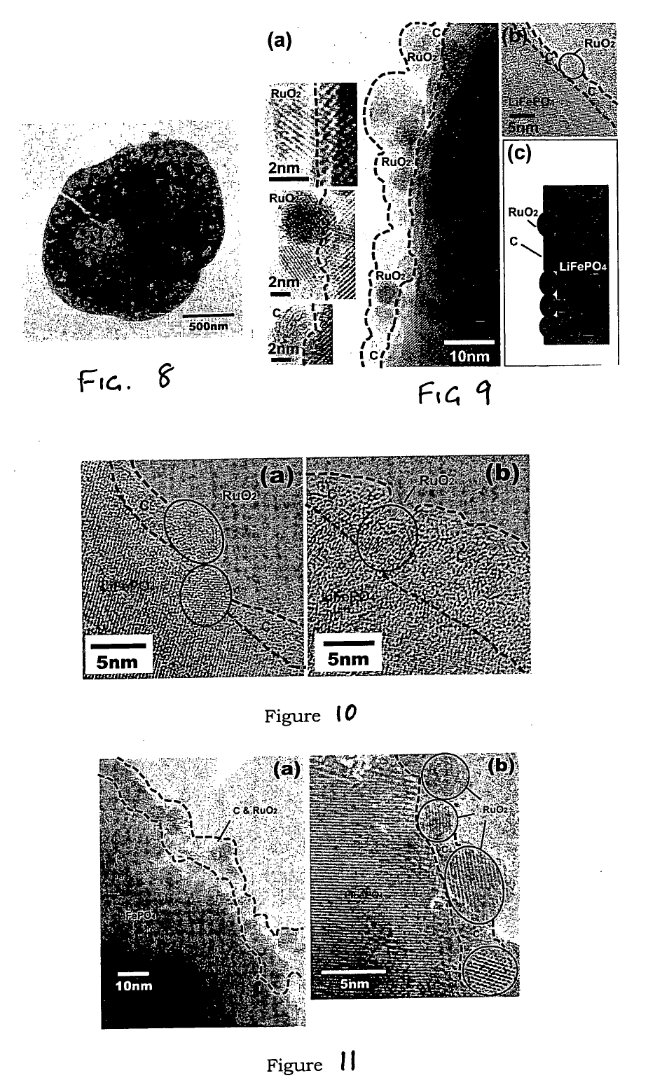

FIGS. 10 (a) and (b) further typical HRTEM image of LiFePO₄ after carbon coating and coating with RuO₂,

FIGS. 11 (a) and (b) yet further typical HRTEM images of LiFePO₄ after carbon coating and coating with RuO₂,

FIG. 12 Typical charge/discharge profiles of carbon coated LiFePO₄ before and after RuO₂ coating at a current rate of C/10, the insert shows the magnified flat region,

FIG. 13 A comparison of the rate performance of carbon coated LiFePO₄ before and after RuO₂ coating,

FIG. 14 Typical X-ray diffraction images of carbon coated LiFePO₄ and LiFePO₄ coated with both carbon and RuO₂, and

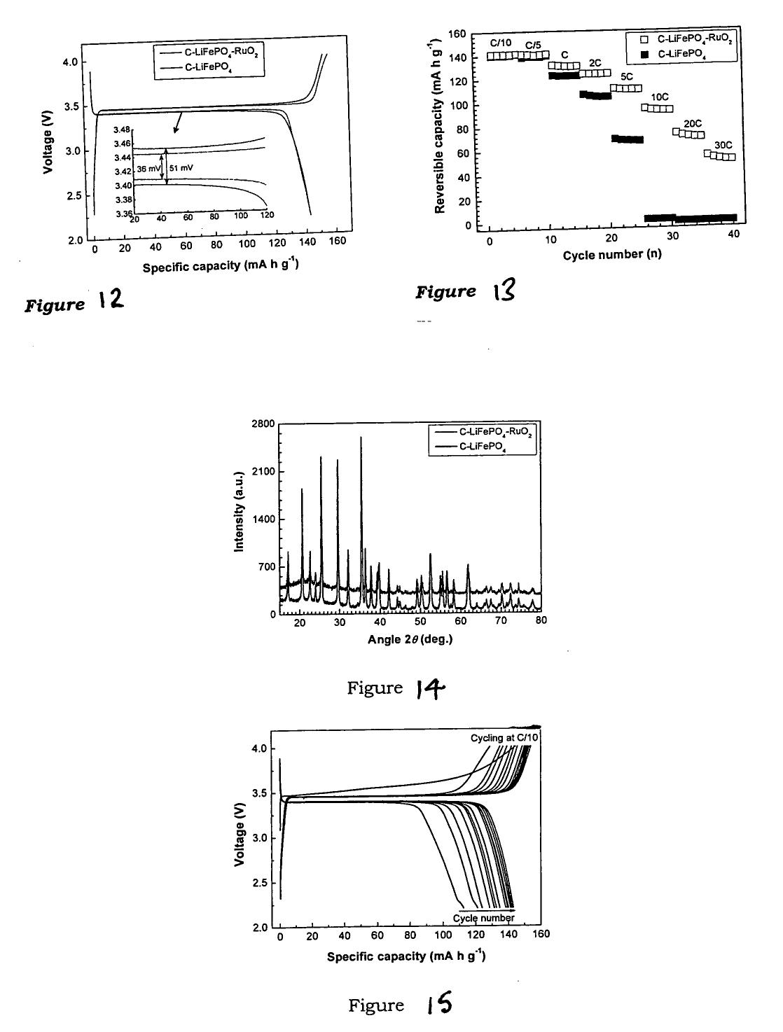

FIG. 15 A diagram similar to FIG. 12 showing a surprising increase in specific capacity as the number of charge/discharge cycles increases.

The general scheme of an optimized nanostructure design of electrode materials, which is still simple to fabricate, is shown in FIG. 1. The schematic drawing (a) shows an electrode 10 made of a material in accordance with the present teaching with an electrode 10 being in contact at one side with an electrolyte 12 present in an electrochemical cell or supercapacitor, e.g. an electrolyte of a lithium battery permitting transport of Li+ ions to and from the electrode 10. At the opposite side of the electrode 10 there is a current collector 14 consisting, e.g. of a metal foil, e.g. a Ti foil. Suitable electrolytes are e.g. described in WO 2004/034489 (EP 03788901.1) and EP-A-1505680.

The material of the electrode is provided with a macropore structure comprising islands or grains of electrode material 16 with passages 18 disposed therebetween. The islands 16 and the passages 18 have macroscale dimensions, i.e. typically in the range from <1 μm to >300 nm and are illustrated as being regularly formed and placed. In practice this is unlikely—the islands and the passages would typically be of slightly or even highly irregular shape but have average cross-sectional dimensions in the range quoted.

The islands 16 are also not solid, but are rather porous, more specifically mesoporous with particles of material 20 and passages 22 between them, as can be seen from the magnified schematic view of a portion of the island 16′ shown in a circle at the top of FIG. 1a. The particles 18 and the passages 22 typically have dimensions in the range 2 nm to 20 nm and are again shown as being regularly formed and placed. As before, this is not essential, the particles 20 and passages 22 could also be of slightly or highly irregular shape, with the particles 20 not necessarily being discrete but possibly joined together at various points and permeated by at least partly interconnected voids forming the passages 22. Thus, the micro-structure of the islands is typically (but not necessarily) similar to the macrostructure of the material itself but to a smaller scale. This concept is expressed in the present description by the term “similar” or “self similar”.

One possible practical realization of this concept is shown in FIG. 1(b). Here the light colored regions are particles of a relatively poorly conducting material TiO₂ which is a useful electroactive material for an electrode of a lithium battery, but has a relatively low electrical conductivity of below 10⁻⁶ S/cm

The particles of TiO₂ are contained in generally spherical islands or grains 16, which can be better visualized by reference to FIG. 5 and which are mesoporous by virtue of the interconnecting voids and passages between the particles 20. The grains of TiO₂ are mixed with carbon black which has a relatively high conductivity (0.1-2 S/cm) and the particles 24 of carbon black are represented in FIG. 1(b) as large black dots. In addition, the particles 20 and islands 26 are permeated with RuO₂ an electronic conductor and this forms a conductive network superimposed on the TiO₂ particles 20 and grains 16. The RuO₂ is shown by small black dots 26 in FIG. 1(b). As can also be seen from FIG. 1(b) the electrolyte 12 permeates the passages 18 between the grains 16 and the interconnected pores, voids or passages 22 of the individual grains.

Thus, an efficient mixed conducting 3D nano-network is introduced into the material with a mesh size of a few nanometers only and with channel widths of comparable size. The way this is done is described later with reference to FIG. 2. As a result of the special mixed conducting three-dimensional network in accordance with the present teaching the insertion kinetics in the electroactive material (here TiO₂) becomes indeed negligible and the insertion rate of Li is enhanced to such a degree that the transport within the channels becomes the limiting factor with respect to the insertion rate. Since the diffusion coefficients D of Li in nano-sized anatase is ˜2×10⁻¹⁵ cm² s⁻¹, as reported in the paper by R. Van de Krol, A. Goossens, J. Schoonman, in J. Phys. Chem. B 1999, 103, 7151, the mean diffusion time <t_{eq}>=L²/2D reduces to 120 s for a mean channel distance of about 7 nm. The need to ensure infiltration of the electrolyte into the mesopores sets a lower limit to the mesh size of the conductive RuO₂ network in the mesopores while the necessity to consider tolerable loss of the electroactive material per volume (meaning that if the passages 18 and 22 are made larger, the amount of electroactive material per unit volume becomes smaller), material stability as well as sufficient connectivity set an upper limit.

This structure design is realized by preparing mesoporous anatase with an average pore size of ca. 7 nm and by subsequently metalizing the pore channels with crystalline RuO₂. It is noteworthy that in addition to the electronic function described in the papers by J. V. Ryan, A. D. Berry, M. L. Anderson, J. W. Long, R. M. Stroud, V. M. Cepak, V. M. Browning, D. R. Rolison, C. I. Merzbacher, in Nature 2000, 406, 169 and P. Balaya, H. Li, L. Kienle, J. Maier, in Adv. Funct. Mater. 2003, 13, 621, RuO₂ also allows for quick Li permeation as described also in the paper by M. Armand, F. Dalard, D. Deroo, C. Mouliom, in Solid State Ionics 1985, 15, 205. Furthermore, RuO₂ is most beneficial as it is—owing to similar bonding properties—expected to spread much better on TiO₂ than carbon would, and thus can efficiently metallize the tiny channels due to the ionic characteristic of both oxides (RuO₂ and TiO₂). The low wetting angle of electrolyte on TiO₂ gives rise to a ready filling of the channels by the liquid electrolyte. As the RuO₂ arrangement is highly porous but percolating, a large number of active triple-phase contacts are formed as well. It is a very fortunate circumstance that the contact of TiO₂ to the electrolyte will result in an increased local conductivity owing to dissociation of the ion pairs. Such dissociation of ion pairs is described by A. J. Bhattacharyya, J. Maier, in Adv. Mater. 2004, 16, 811. This effect is particularly pronounced if the channel width is of the order of the screening length. Even though such a mesoporous material is crucial to warrant good electronic and ionic contacts on the nanoscale, a feasible electrode design in addition requires a superstructure on a larger scale. One reason is the sheer fact that fabrication of a mesoporous monolith of electrode dimensions is—if possible at all—very intricate and expensive. The second reason is more fundamental and refers to the fact that a large mesoporous monolith can be hardly infiltrated with electrolyte. The surface interaction provides the necessary driving force (capillary pressure) yet will also lead to a significant pressure loss if the monolith is large.

The inventive concept of superimposing onto the mesoporous structure a similar network on the microscale, with the mesh size being given by the size of the mesoporous particles and with the channel width being selected as a compromise between realization of quick transport and loss of electroactive material, i.e. its absence in the volume of the electrode, is actually quite straightforward to achieve. Owing to the less demanding kinetics on the micrometer scale this design is most straightforwardly arrived at by the composite of mesoporous particles and the conducting admixture (e.g., carbon black and RuO₂ or just RuO₂). In the end, as regards qualitative phase distribution and functionality, the hierarchical structure achieved is self-similar on the transition from nanoscale to microscale (see FIG. 1).

The synthesis of the mesoporous TiO₂:RuO₂ nanocomposite, which meets this design and shows excellent high rate capability when used as anode materials for lithium batteries will be described in more detail in the following. Nanostructure titania has been of considerable interest as a promising anode material for lithium batteries because of high reversibility of Li insertion/extraction at a low-voltage. This reversibility is e.g. described in the papers by L. Kavan, M. Grätzel, S. E. Gilbert, C. Klemenz, H. J. Scheel, in J. Am. Chem. Soc. 1996, 118, 6716A. R. Armstrong, G. Armstrong, J. Canales, R. Garcia, P. G. Bruce, in Adv. Mater. 2005, 17, 862; Y. G. Guo, Y. S. Hu, J. Maier, in Chem. Commun. 2006, 2783; Y. S. Hu, L. Kienle, Y. G. Guo, J. Maier, in Adv. Mater. 2006, 18, 1421; and E. Baudrin, S. Cassaignon, M. Koelsch, J. P. Jolivet, L. Dupont, J. -M. Tarascon, in Electrochem. Commun., 2007, 9, 337.

A first example will now be given for the preparation of an electroactive material based on TiO₂.

### EXAMPLE I

For the preparation of a material in accordance with the present teaching, mesoporous anatase sub-micron spheres with a uniform grain size (˜300 nm) (see FIG. 5) and with surface area of ca. 130 m² g⁻¹ were prepared, according to the method proposed in the paper by Y. G. Guo, Y. S. Hu and Jo. Maier in Chem. Community 2006, 2783. by using a TiO₂-CdSO₄ composite as intermediate. Peak positions and widths in the X-ray diffraction (XRD) pattern as shown in FIG. 2a of the as-prepared mesoporous TiO₂ spheres confirm the fabrication of pure anatase nanocrystalline TiO₂ with a mean crystallite size of D₁₀₁ along the [101] axis of ca. 7 nm estimated from the widths of the major diffraction peak (2θ=25.3°) by Scherrer's formula. Internal metallization of the mesoporous TiO₂ spheres was carried out by wetting the TiO₂ powder with 0.1M RuCl₃ solution followed by heat treatment at 450° C. under O₂. The successful introducing of RuO₂ is shown in the XRD pattern of FIG. 2b for the resulting sample by the appearance of two new diffraction peaks at 2θ=28.0° and 35.1°, which can be indexed as the 110 and 101 planes of the tetragonal phase of RuO₂ (JCPDS No. 40-1290). The amount of RuO₂ is about 5 wt-% corresponding to a complete transformation of RuCl₃ to RuO₂.

The distribution of crystalline RuO₂ within the porous TiO₂ spheres was characterized using a Zeiss Libra 200FE transmission electron microscope (TEM) operated at 200 kV and equipped with a scanning unit and an energy-dispersive X-ray (EDX) analyzer. FIG. 3a shows a typical annular dark-field TEM image taken from a TiO₂ sphere along with corresponding Ti and Ru maps. All together, this clearly points towards a uniform distribution of RuO₂ down to the 10 nm scale. As visually traced from the high resolution TEM image of FIG. 3b taken from the outer edges of a TiO₂ sphere, the as-deposited RuO₂ nanoparticles form a 3D interconnected network over a portion of the inner surface of the mesopore walls that connects the carbon network on the microscale (FIG. 3c). It is worth noting that the electronic wiring with RuO₂ does not change the nanostructure of the parent mesoporous TiO₂ spheres. This can be seen by a comparison of FIGS. 5 (especially 5(b)) and 6.

At this stage it is useful to consider the performance of conventionally prepared anatase and carbon composite electrodes. FIG. 4, in which rates of up to 30C (one lithium per formula unit in 1/30 hour, i.e., 10.08 A g⁻¹) have been employed, compares 300 nm-sized anatase (FIG. 4(a)) with 5 nm-sized anatase (FIG. 4(b)) as well as with mesoporous TiO₂ but without interior metallization (FIG. 4(c)). Both the nano-sized and the mesoporous anatase exhibit much higher capacity and better cycling performance than the 300 nm-anatase. The extent to which compound formation plays a role in the nanostructured anatase is not yet known. At low current rates, the mesoporous TiO₂ has comparable performance with nano-sized anatase (5 nm TiO₂). At high current rates above 10C, its performance becomes worse. In contrast to the electrolyte which can penetrate into the mesopores, the carbon admixture only contacts the surfaces of the mesoporous grains 16.

For comparison purposes, FIG. 4(d) now shows the outstanding rate performance of the obtained mesoporous TiO₂:RuO₂ composite after introducing internal metallization via the mixed-conducting network structure. This is confirmed by the curves of FIG. 7 which are galvanostatic discharge/charge curves for a mesoporous TiO₂:RuO₂ electrode cycled at different rates from C/5 to 30C between voltage limits of 1V and 3V. Since RuO₂ also contributes to the capacity in the voltage range of 1-3 V, the capacity of the TiO₂:RuO₂ composite was calculated based on the whole mass (it is noted that no Ru/Li₂O nanocomposite is formed in this voltage range).

The cell was first cycled at C/5 and, after 20 cycles, the rate was increased in stages to 30C. A specific charge capacity of around 214 mA h g⁻¹ was obtained at a rate of C/5 after 20 cycles; this value reduces to 190 mA h g⁻¹ at 1C, to 147 mA h g⁻¹ at 5C, and to 125 mA h g⁻¹ at 10C. At the very high rate of 30C (discharge/charge of all the TiO₂ within 2 min!), the specific charge capacity is still 91 mA h g⁻¹, which is about two times larger than that of 5 nm anatase (48 mAh g⁻¹) and nine times larger than that of mesoporous anatase spheres without interior electronic wiring (10 mAh g⁻¹). The reversibility is demonstrated by the fact that the capacity of 210 mA h g⁻¹ is returned to if the rate is lowered to C/5 (not shown here). So far as can be ascertained, such a good performance at these high rates has never been found before. Especially, the performance at such high rates is much better than those of commercial TiO₂, nano-sized anatase, TiO₂-B nanowires, and nano-sized rutile. The best prior result known to date seems to be that achieved in the above referenced paper by Owen et al. However, these authors only used a maximum rate of 8.9 C (i.e., 3 A g⁻¹) and used porous TiO₂ thin films with low diffusion distances but relatively low absolute capacities.

Thus, the present invention relates to a new design of electrodes achieved by fabricating a hierarchically nanostructured electrode with highly efficient mixed conducting 3D networks on both nanoscale and microscale levels. A key to its realization is, besides the preparation of mesopores, the use of a suitable electronic conductor—here the oxide RuO₂—that enables favorable surface-surface interactions between the RuO₂ and the TiO₂. The nano-sized network provides negligible diffusion times, enhanced local conductivities and possibly faster phase transfer reactions, and thus plays a key role in achieving the extremely good power performance. The microscopic network guarantees high absolute capacities, ease of fabrication and quick infiltration. The whole procedure is simple, yet very effective and, owing to its versatility, could also be extended to other anode and cathode materials used in lithium batteries and to porous conducting materials in general.

A specific example of the synthesis of the TiO₂-RuO₂ electrode material in accordance with the present invention will now be given.

In this synthesis, one solution containing 0.92 g cadmium acetate dihydrate (Merck), 0.38 g thiourea (Merck), and 0.38 g 1-thioglycerol (Sigma) in 40 mL of N,N-dimethylformamide/water (3:1, in volume) solvent was added into 80 mL of continuously stirred butanol solution with 3 mL Ti(OBu)₄ (Aldrich) and 0.6 mL acetylacetone (Aldrich) at room temperature. Then the mixture was stirred for 20 min and refluxed at 140° C. for about 3 h. The as-produced white precipitates were collected by using centrifuge and repeatedly washed with ethanol and distilled water. The Ti—Cd precursor was calcined at 500° C. under air for 5 h to obtain crystalline TiO₂/CdSO₄ composites. To form the mesoporous TiO₂ spheres CdSO₄ was completely removed in 10 wt-% HNO₃ aqueous solution, followed by thorough rinsing with distilled water. To prepare mesoporous TiO₂:RuO₂ spheres, 133 mg obtained mesoporous TiO₂ spheres were wetted by 0.5 mL of 0.1 M RuCl₃ solution. After drying under air, the powders were transferred into a tube furnace and calcined at 450° C. for 1 h under O₂.

XRD measurements were carried out with a PHILIPS PW3710 using filtered Cu Kα radiation. A JEOL 6300F scanning electron microscope (SEM) was used to investigate the morphology of the materials. TEM and HRTEM images were collected by using a JEOL 2000EX (operating at 200 kV) and a JEOL 4000EX (operating at 400 kV) transmission electron microscopes, respectively. Ti and Ru maps were collected by using a Zeiss Libra 200FE transmission electron microscope (operating at 200 kV) equipped with a scanning unit and an energy-dispersive X-ray (EDX) analyzer (EDAX, Ametek, USA). The nitrogen adsorption and desorption isotherms at 77.4 K were obtained with an Autosorb-1 system (Quanta Chrome) after the sample was degassed in vacuum at 120° C. overnight.

Electrochemical experiments were performed using two-electrode Swagelok-type™ cells. For preparing working electrodes, a mixture of the various samples of TiO₂, i.e. commercial TiO₂ (anatase) in 5 nm and 300 nm particle sizes, mesoporous TiO₂ and the TiO₂:RuO₂ composite of the present invention were each mixed with carbon black and poly (vinyl difluoride) (PVDF) at a weight ratio of 60:20:20, were pasted on pure Cu foil (99.6%, Goodfellow). Glass fiber (GF/D) from Whatman® was used as a separator. The electrolyte consists of a solution of 1 M LiPF₆ in ethylene carbonate (EC)/dimethyl carbonate (DMC) (1:1, in volume) obtained from Ube Industries Ltd. Pure lithium foil (Aldrich) was used as counter electrode. The discharge and charge measurements were carried out under a similar electrochemical condition on an Arbin MSTAT system. The cells were assembled in an argon-filled glove box.

### EXAMPLE II

This example relates to lithium iron phosphate (LiFePO₄) which, as described in the paper by Padhi, A. K.; Nanjundaswamy, K. S.; Goodenough, J. B. J. Electrochem. Soc. 1997, 144, 1188.

Work on this compound by a variety of scientists has shown that it has numerous appealing features such as high theoretical capacity (170 mA h g⁻¹), acceptable operating voltage (3.4 V vs. Li⁺/Li), high safety, environmental benignity, low cost, etc. The scientific work on LiFePO₄ is described in the papers by Croce, F.; Epifanio, A. D.; Hassoun, J.; Deptula, A.; Olczac, T.; Scrosati, B. Electrochem. Solid State Lett. 2002, 5, A47. Wang, D. Y.; Li, H.; Shi, S. Q.; Huang, X. J.; Chen, L. Q. Electrochim. Acta 2005, 50, 2955, Delacourt, C.; Poizot, P.; Levasseur, S.; Masquelier, C. Electrochem. Solid State Lett. 2006, 9, A352, Doeff, M. M.; Hu, Y.; McLarnon, F.; Kostecki, R. Electrochem. Solid State Lett. 2003, 6, A207, Zaghib, K.; Guerfi, A.; Charest, P.; Striebel, K. A. Electrochem. Solid State Lett. 2005, 8, A207, Chen, G.; Song, X.; Richardson, T. J. Electrochem. Solid State Lett. 2006, 9, A295, Dominko, R.; Bele, M.; Gaberscek, M.; Remskar, M.; Hanzel, D.; Pejovnik, S.; Jamnik, J. J. Electrochem. Soc., 2005, 152, A607, Park, K. S.; Schougaard, S. B.; Goodenough, J. B. Adv. Mater. In press, Wang, Q.; Zakeeruddin, S. M.; Wang, D.; Exnar, I.; Grätzel, M. Angew. Chem. Int. Ed. 2006, 45, 8197, Xie, H. M.; Wang, R. S.; Ying, J. R.; Zhang, L. Y.; Jalbout, A. F.; Yu, H. Y.; Yang, G. L.; Pan, X. M.; Su, Z. M. Adv. Mater. 2006, 18, 2609, Wang, Y.; Wang, J.; Yang, J.; Nuli, Y. Adv. Func. Mater. 2006, 16, 2135, Prosini, P. P.; Lisi, M.; Zane, D.; Pasquali, M. Solid State Ionics 2002, 148, 45,

It has thus attracted extensive interest as a potential candidate for replacing the commercial layered LiCoO₂ material, which shows a relative low capacity and low safety. However, the biggest disadvantage of LiFePO₄ is its sluggish mass and charge transport, as corroborated by a recent work on the electrical measurement on a single crystal by Amin, R.; Balaya, P.; Maier, J. Electrochem. Solid State Lett. 2007, 10, A13.

Tremendous efforts have been made to overcome the electronic- and ionic-transport limitations by doping with foreign atoms or by decreasing the particle size or by using a reversible redox couple or by coating electronically conductive agents (carbon, Ag, conducting polymers, etc.). The carbon-coating technique is widely applied and was most systemically studied by Jamnik et al. as described in the above referenced papers. However, the rate performance enhancement of such electrode materials is still limited, as availability or percolation of the electronically conducting phase become insufficient at very high rates. It seems that the thickness of carbon layer on the surface of LiFePO₄ particles is different on the different crystal planes of LiFePO₄. There is even no carbon on some places. That means carbon will not cover all the surface of LiFePO₄ particles, leading to a non-continuous electronically conducting network. The reason is that carbon and LiFePO₄ have different surface properties. One also has to consider the wetting properties and/or surface-surface interactions when selecting the suitable coating material beyond its electronic function.

The work previously conducted has mainly been carried out on solid LiFePO₄, however some proposals have also been made for the preparation of porous LiFePO₄, notably in the paper by Jamnik et al in The Journal of the Electrochemical Society 152(5) A858-A863 (2005). This paper describes the preparation of porous LiFePO₄ and the carbon coating of the porous material which is formed at the same time as the porous material. The content of that paper with respect to the preparation of the porous LiFePO₄ carbon coated material is incorporated herein by reference. However, as mentioned above, there is a significant problem with the fact that the LiFePO₄ is not coated with a continuous network of carbon.

The present invention is able to overcome this difficulty. More specifically, it has been found that nanosized RuO₂ can be used to to ‘metalize’ tiny pores and even to ‘repair’ incomplete electronically conducting (carbon) networks in porous carbon-containing LiFePO₄, the kinetics and rate capability of the composite are significantly improved.

This is realized by using a low-temperature, solution-infiltration approach that nano-sized RuO₂ is deposited on carbon-containing porous LiFePO₄ by cryogenic decomposition of ruthenium tetroxide (RuO₄), which has previously been used as a precursor to prepare RuO₂ thin films at rather low temperature as described in the paper by Yuan, Z.; Puddephatt, R. J.; Sayer, M. Chem. Mater. 1993, 5, 908.

Carbon-containing (˜3 wt-%) porous LiFePO₄ composite materials were prepared by a sol-gel method. 0.01 mol of lithium phosphate (Li₃PO₄, Aldrich 33,889-3) and 0.02 mol of phosphoric (V) acid (H₃PO₄, Aldrich 31,027-1) were dissolved in 200 mL water by stirring at 70° C. for 1 h. Separately, 0.03 mol of iron (III) citrate (Aldrich, 22,897-4) was dissolved in 300 mL of water by stirring at 62° C. for 1 h. The two solutions were mixed together and dried at 60° C. for 24 h. After thorough grinding with a mortar and pestle, the obtained material was fired in inert (argon) atmosphere at 700° C. for 10 h. The heating rate was 10° C./min. Aqueous RuO₄ (˜0.5 wt-%) solution was received from Strem Chemicals. A certain amount of porous C—LiFePO₄ was placed in a tube-like flask with a sidearm. About 2 mL of pentane was condensed in the sidearm, then warmed to room temperature and allowed to equilibrate with the porous C—LiFePO₄ for some time. By slowly cooling the flask, the pentane condensed in the flask and covered and filled the porous C—LiFePO₄. Solution of RuO₄ in pentane with a very low melting point and low viscosity was used to minimize capillary forces on the C—LiFePO₄ during wetting at such critical conditions. 10 mL of pentane was employed to extract RuO₄ from aqueous RuO₄ (˜10 mL). A certain amount of solution of RuO₄ in pentane was added to the flask containing the porous C—LiFePO₄ pre-cooled to −78° C. in a dry ice/acetone bath. The flask was allowed to warm slowly to room temperature over a period of several days. All the operations were carried out in a well-vented hood. Until all the pentane was evaporated in the flask, the obtained dry sample was put into a vacuum oven and heated at 200° C. for 1 h. The amount of RuO₂ is about ˜4 wt-% corresponding to a complete extraction and transformation of RuO₄.

### Structural and Electrochemical Characterizations

XRD measurements were carried out with a PHILIPS PW3710 using filtered Cu K□ radiation. TEM and HRTEM measurements were performed a JEOL 4000EX (operating at 400 kV) transmission electron microscopes, respectively. Electrochemical experiments were performed using two-electrode Swagelok-type™ cells. For preparing working electrodes, a mixture of the samples of C—LiFePO₄ (C—LiFePO₄—RuO₂), carbon black, and poly (vinyl difluoride) (PVDF) at a weight ratio of 80:10:10, was pasted on pure Al foil (99.6%, Goodfellow). Glass fiber (GF/D) from Whatman® was used as a separator. The electrolyte consists of a solution of 1 M LiPF₆ in ethylene carbonate (EC)/dimethyl carbonate (DMC) (1:1, in volume) obtained from Ube Industries Ltd. Pure lithium foil (Aldrich) was used as counter electrode. The cells were assembled in an argon-filled glove box. The discharge and charge measurements were carried out under an identical electrochemical condition on an Arbin MSTAT system.

In order to coat the porous carbon coated LiFePO₄ a solution of RuO₄ in pentane is infiltrated into the porous carbon coated LiFePO₄ and its temperature is increased slowly from −78° C. after equilibration with the carbon-containing porous LiFePO₄. The RuO₂ preferentially forms on the bare surface of LiFePO₄ rather than on the surface of carbon due to the similar ionic characteristic of the two compounds (LiFePO₄ and RuO₂). This point is clearly supported by the HRTEM measurements whose results are shown in FIG. 9 and in FIGS. 10 and 11. It can be seen from these features that nano-sized RuO₂ with a particle size of about 5 nm is directly deposited on the bare surface of LiFePO₄ instead of on the carbon surface which has been confirmed by extensive HRTEM studies. The non-continuous electronically conducting network of carbon is “repaired” because of the RuO₂ preferential deposition on the bare surface of LiFePO₄. As the RuO₂ arrangement is also porous and as percolation occurs, a large number of active triple-phase (RuO₂, LiFePO₄, liquid electrolyte) contacts are formed, greatly facilitating Li insertion. The boundary between RuO₂ and LiFePO₄ can be readily observed, indicating the good wetting properties as seen in FIG. 9(a). It is worth noting that after further coating with RuO₂, the resulting C—LiFePO₄:RuO₂ composite still retains the morphology, porous and crystal structure of the porous C—LiFePO₄ substrate, as corroborated by TEM and XRD measurements shown in FIGS. 8 and 14.

In order to check the potential application in high-power Li batteries, the electrochemical performance for Li insertion/extraction has been investigated. Before discussing the results, it is useful to briefly consider the performance of the carbon-containing porous LiFePO₄, which was successfully prepared by Jaminik et al. After several initial cycles, the reversible capacity stabilizes at about 140 mA h g⁻¹. All the electrochemical results discussed below are the stable performance obtained after several initial cycles. FIG. 12 shows the typical charge/discharge profiles of carbon-containing porous LiFePO₄ before and after nano-sized RuO₂ coating at a current rate of C/10 (one lithium per formula unit in 10 hours). After RuO₂ coating, the polarization between the charge and discharge plateaus is reduced to 36 mV from the 51 mV for the sample without RuO₂ coating, indicating that the kinetics of the LiFePO₄ is indeed improved after RuO₂ coating. FIG. 13 shows the comparison of rate performance of carbon-containing porous LiFePO₄ before and after RuO₂ coating, where rates of up to 30C have been employed. At low rates, they exhibit comparable performance. However, at higher rates, the difference is very clear, e.g. specific reversible capacities of 124 and 93 mA h g⁻¹ were obtained at rates of 2C and 10C respectively for the sample after RuO₂ coating, which is much higher than those of the sample before RuO₂ coating. These results reveal that carbon coating on porous LiFePO₄ works fine for lithium insertion at low current rates but does not at high current rates due to the insufficient electronically conducting network. After “repairing” the electronically conducting network by nano-sized RuO₂, the kinetics and rate capability of the composite are significantly improved. The results here give clear evidence of the utility of RuO₂ in generating very effective mixed conducting heterogeneous electrodes.

We proposed a new design by fabricating a hierarchically nanostructured electrode with highly efficient mixed conducting 3D networks on both nanoscale and microscale levels. A key to its realization is, besides the preparation of mesopores, the use of a suitable electronic conductor—here the oxide RuO₂—that enables favorable surface-surface interactions. While the nano-sized network provides negligible diffusion times, enhanced local conductivities and possibly faster phase transfer reactions, and hence is the key to the extremely good power performance, the microscopic network guarantees high absolute capacities, easy of fabrication and quick infiltration. The whole procedure is simple, yet very effective, and owing to its versatility, could also be extended to other anode and cathode materials used in lithium batteries, such as Li₄Ti₅O₁₂, V₂O₅, LiCoO₂, LiMn₂O₄, LiCoₓNi_{y}Mn_{1-x-y}O₂ (0<x<1, 0<y<1, 0<x+y<1), LiMnPO₄ and so on.

Although the above examples have all utilized RuO₂ as the conductive metal oxide other electronically conducting metal oxides can also be used, for example IrO₂, VO₂, MoO₂, WO₂, Co₃O₄ and Fe₃O₄.

As mentioned above the material of the invention can also comprise particles of a conductive material dispersed in the active material and present in the passages 18. The particles of conductive material preferably comprise carbon black.

The active material preferably comprises generally spherical mesoporous grains of one of TiO₂ and LiFePO₄ of a diameter in the range from 400 to 2000 nm with mesopores having cross-sectional dimensions in the size range from 2 to 50 nm with a conducting network of crystalline RuO₂ coating the grains and extending inside the mesopores, with the proportion of RuO₂ to TiO₂ being in the range from 4% to 20% by weight, with particles of carbon black having diameters in the range from generally 30 nm to 50 nm being interspersed with the mesoporous grains and located in the passages between the grains and optionally in the mesopores and with the proportion of carbon black lying in the range from the range from 10 to 30% by weight of the combined weight of TiO₂ and RuO₂ or of LiFePO₄ and RuO₂.

The RuO₂ generally fills any non-continuities between adjacent grains of carbon black, i.e. gaps between them. The application of this invention is not restricted to the lithium batteries and can also be extended to other electrochemical devices such as supercapacitors and photoelectrochemical devices such as Dye-sensitized solar cells (DSSC) where TiO₂ is used as a photoelectrode.

1-21. (canceled)

22. A material comprising a poorly conducting active material of relatively low conductivity having regular or irregular passages having average cross-sectional dimensions generally in the size range from 5 μm to 200 nm and interconnected mesopores having average cross-sectional dimensions in the size range from 2 to 50 nm and the active material being covered with a network of an electronically conductive metal oxide of relatively high conductivity extending into said mesopores.

23. A material in accordance with claim 22, wherein particles of a conductive material are dispersed in the active material and present in said passages.

24. A material in accordance with claim 22, wherein said active material is an active electrode material for an electrochemical device such as an electrochemical cell, a storage battery, a supercapacitor, a fuel cell or a photoelectrochemical device.

25. A material in accordance with claim 22, wherein the active material is present in the form of an agglomeration of mesoporous grains or generally spherical mesoporous bodies of the active material with the passages being present between the mesoporous grains or generally spherical mesoporous bodies.

26. A material in accordance with claim 25, wherein the grains or generally spherical bodies themselves comprise an agglomeration of finer grains or finer generally spherical bodies with the interconnected mesopores being present as channels between the finer grains or the finer generally spherical bodies.

27. A material in accordance with claim 22, wherein said active material is selected from the group comprising TiO₂, LiFePO₄, Li₄Ti₅O₁₂, V₂O₅, LiCoO₂, LiMn₂O₄, LiCoₓNi_{y}Mn_{1-x-y}O₂ (0<x<1, 0<y<1, 0<x+y<1) and LiMnPO₄.

28. A material in accordance with claim 22, wherein the electronically conducting metal oxide is selected from the group comprising RuO₂, IrO₂, VO₂, MoO₂, WO₂, Co₃O₄ and Fe₃O₄.

29. A material in accordance with claim 23, wherein the particles of conductive material comprise carbon black.

30. A material in accordance with claim 29, wherein the active material comprises generally spherical mesoporous grains of one of TiO₂ and LiFePO₄ of a diameter in the range from 400 to 2000 nm with mesopores having cross-sectional dimensions in the size range from 2 to 50 nm with a conducting network of crystalline RuO₂ coating the grains and extending inside the mesopores, with the proportion of RuO₂ to TiO₂ being in the range from 4% to 20% by weight, with particles of carbon black having diameters in the range from generally 30 nm to 50 nm being interspersed with the mesoporous grains and located in the passages between the grains and optionally in the mesopores and with the proportion of carbon black lying in the range from 10 to 30% by weight of the combined weight of TiO₂ and RuO₂.

31. A material in accordance with claim 30, wherein the RuO₂ generally fills any discontinuities between adjacent grains of carbon black.

32. A material in accordance with claim 22 when used in one of an electrochemical cell and a supercapacitor.

33. A method of making a material in particular for use in electrochemical cells or supercapacitors comprising the steps of preparing a poorly conducting active material of relatively low conductivity having regular or irregular passages having average cross-sectional dimensions generally in the size range from 5 μm to 200 nm and interconnected mesopores having average cross-sectional dimensions in the size range from 2 to 50 nm and covering the active material with a network of an electronically conductive metal oxide of relatively high conductivity extending into said mesopores.

34. A method in accordance with claim 33, wherein particles of a conductive material are dispersed in the passages of said active material before or after covering the active material with a network of an electronically conductive material.

35. A method in accordance with claim 33, wherein said active material is prepared in the form of an active electrode material for an electrochemical device such as an electrochemical cell, a storage battery, a supercapacitor, a fuel cell or a photoelectrochemical device.

36. A method in accordance with claim 33, wherein the active material is prepared by preparing mesoporous grains or generally spherical mesoporous bodies of the active material covering the grains or generally spherical bodies externally and internally with a network of the electronically conducting material and mixing the grains or spherical bodies with a conductive particulate material to form an agglomeration of said covered active material and said conductive particulate material.

37. A method in accordance with claim 33, wherein said active material is selected from the group comprising TiO₂, LiFePO₄, Li₄Ti₅O₁₂, V₂O₅, LiCoO₂, LiMn₂O₄, LiCoₓNi_{y}Mn_{1-x-y}O₂ (0<x<1, 0<y<1, 0<x+y<1) and LiMnPO₄.

38. A method in accordance with claim 35, wherein the electronically conducting metal oxide is selected from the group comprising RuO₂, IrO₂, VO₂, MoO₂, WO₂, Co₃O₄ and Fe₃O₄.

39. A method in accordance with claim 34, wherein the particles of conductive material are selected to be carbon black.

40. A method in accordance with claim 39, wherein the active material is prepared as generally spherical mesoporous grains of one of TiO₂ and LiFePO₄ of a diameter in the range from 400 to 2000 nm, with mesopores having cross-sectional dimensions in the size range from 2 to 30 nm, with a conducting network of crystalline RuO₂ coating the grains and extending inside the mesopores, with the proportion of RuO₂ to TiO₂ being in the range from 4% to 20% by weight and with the particles of carbon black being selected to have diameters in the range from generally 30 nm to 50 nm and being interspersed with the mesoporous grains and located in the passages between the grains and optionally in the mesopores and with the proportion of carbon black lying in the range from 10 to 30% by weight of the combined weight of TiO₂ and RuO₂.

41. A material in accordance with claim 30, wherein the RuO₂ is first added to form the network covering the active material after the carbon black has been admixed to it and thereby generally fills any discontinuities between adjacent particles of carbon black.

42. A method in accordance with claim 32, wherein RuO₂ is used as the material forming the electronically conducting network and is applied to the active material, optionally after admixing of a conductive material, in the form of RuCl₃ and is subsequently oxidized to RuO₂ by heating in air or oxygen.

43. A method in accordance with claim 32, wherein the active material is TiO₂ and is prepared in the form of mesoporous generally spherical bodies by taking a Ti, Cd, O and S containing precursor, heating it in air to obtain crystalline TiO₂/CdSO₄ composites and removing the CdSO₄ in a dilute nitric acid solution followed by washing with distilled water and drying.
